(19) United States
(12) Patent Application Publication
(10) Pub. No.: US 2016/0290463 A1
(43) Pub. Date: Oct. 6, 2016

(54) MOTOR VEHICLE DRIVE TRAIN

(71) Applicant: Voith Patent GmbH, Heidenheim (DE)

(72) Inventors: Kai Kamossa, Crailsheim (DE); Kurt Adleff, Crailsheim (DE)

(73) Assignee: Voith Patent GmbH, Heidenheim (DE)

(21) Appl. No.: 15/180,658

(22) Filed: Jun. 13, 2016

Related U.S. Application Data
(63) Continuation of application No. PCT/EP2014/076951, filed on Dec. 9, 2014.

(30) Foreign Application Priority Data
Dec. 13, 2013 (DE) 10 2013 225 954.9

(51) Int. Cl. F16H 47/06; F16D 11/00; F02B 37/00; F16D 57/04; B60T 10/02; F16F 15/16; F16D 23/02

(52) U.S. Cl. CPC F16H 47/06; F16F 15/16; F16D 11/00; F16D 23/02; F16D 57/04; B60T 10/02; F02B 37/00

(57) ABSTRACT

A motor vehicle drive train, comprising a drive engine including a drive shaft and generating an exhaust stream; a power turbine configured to convert exhaust energy into drive power and capable to drive the drive shaft or an assembly downstream of the driveshaft in the drive power flow with drive power of the drive turbine; a hydrodynamic retarder including a driven bladed primary wheel and a bladed secondary wheel that is stationary or driven in the opposite direction of the primary wheel, the primary wheel and the secondary wheel forming a working chamber that can be filled with a working medium capable of braking the primary wheel hydrodynamically by torque transmission from the primary wheel to the secondary wheel by way of a working medium circuit; and a mechanical disconnect clutch capable of disengaging the power turbine and the primary wheel of the hydrodynamic retarder from the drive power flow.

### CROSS REFERENCE TO RELATED APPLICATIONS

This is a continuation of PCT application No. PCT/EP2014/076951, entitled “MOTOR VEHICLE DRIVETRAIN”, filed Dec. 9, 2014, which is incorporated herein by reference.

### BACKGROUND OF THE INVENTION

1. Field of the Invention

The current invention relates to a motor vehicle drive train, in particular for a commercial vehicle such as a truck, construction machinery, agricultural vehicle or special vehicle, or for a rail vehicle.

2. Description of the Related Art

In accordance with generic motor vehicle drive trains, a drive engine, in particular a combustion engine, for example a diesel engine that includes a drive shaft and generates an exhaust stream is used for supplying the drive power to the motor vehicle drive train, wherein a so-called turbo-compound system is provided for efficiency improvement, for example in addition to an exhaust turbocharger for the purpose of turbocharging the drive engine. A turbo-compound system of this type includes a power turbine positioned in the exhaust stream for converting exhaust energy into drive power, whereby the power turbine is switchable into a drive connection with the drive shaft, so that the drive power gained from the exhaust energy by way of the power turbine can be added to the drive power of the drive engine for driving the motor vehicle drive train in order to drive the driving wheels and/or another assembly of the drive train.

Although a turbo-compound system leads to an efficiency increase in the nominal operating point of the drive engine, wherein for example with the same usage ten percent higher drive power is available or wherein, with the same drive power consumption savings can accordingly be achieved; there are conditions in partial load operation of the drive engine whereby due to the small amount of available exhaust energy hardly any additional drive power can be generated. Due to the unavoidable mechanical losses in the turbo-compound system, for example in the bearings of the exhaust gas power turbine as well as in the mechanical drive connection via which the power turbine is connected to the motor vehicle drive train, operational conditions may even occur whereby the efficiency of the drive engine compared to a drive engine without turbo-compound system is worsened.

What is needed in the art is a motor vehicle drive train with a turbo-compound system whose overall balance efficiency is improved.

### SUMMARY OF THE INVENTION

The present invention provides a motor vehicle drive train, in particular for a commercial vehicle or rail vehicle, including a drive engine that includes a drive shaft and generates an exhaust stream, as well as a power turbine positioned in the exhaust stream for converting exhaust energy into drive power. The power turbine is switchable into a drive connection with the drive shaft in order to drive the drive shaft or an assembly in the operating sequence downstream from said drive shaft with the drive power of the power turbine.

The present invention also provides a hydrodynamic retarder, including a driven bladed primary wheel, also referred to as a rotor; and a stationary bladed secondary wheel, also referred to as a stator; whereby the two bladed wheels together form a working chamber that can be filled with a working medium, for example water or oil or a mixture containing one of these substances, in order to—by way of driving the primary wheel—create a working medium circulation in the working chamber by way of which torque is transferred from the primary wheel to the secondary bladed wheel, thus braking the primary wheel hydrodynamically. Instead of having a stationary secondary wheel, the secondary wheel can also be driven in the opposite direction of the primary wheel in a so-called counter-rotating retarder, in particular via a common input shaft of the hydrodynamic retarder.

The present invention further provides a mechanical disconnect clutch, by way of which the power turbine and the primary wheel of the hydrodynamic retarder can be disengaged from the drive power flow in the motor vehicle drive train.

According to the present invention, not only the mechanical losses in the turbo-compound system as described are avoided in the drive connection to the power turbine and in the power turbine in selected operational conditions, in particular if the power turbine is disengaged from the drive power flow. Otherwise undesirable losses occurring in the non-braking operation of the hydrodynamic retarder due to a residual braking torque produce by the retarder and/or also due to mechanical losses, for example in bearings, are also avoided. The arrangement according to the invention qualifies the additional engineering effort and at the same time the additional expenditure in production costs by advantageously using the same mechanical disconnect clutch for two entirely different assemblies of the vehicle drive train, both of which to date produced undesirable losses only in certain operational conditions.

The optional mechanical disengagement of a hydrodynamic retarder and a power turbine of a turbo-compound system from the drive power flow in the motor vehicle drive train by way of a common mechanical disconnect clutch is especially advantageous, since both systems are active in complementary operational conditions of the motor vehicle drive train, namely the hydrodynamic retarder when braking the motor vehicle and thereby generally in propulsion operation of the drive engine, and the turbo-compound system during traction operation of the motor vehicle, that is with active driving power input of drive power from the drive engine into the motor vehicle drive train, in order to drive the driving wheels and/or another assembly with the drive engine.

The mechanical disconnect clutch therefore includes especially advantageously at least two switching positions, including a first switching position where the power turbine is engaged in drive connection with the drive shaft and where at the same time the primary wheel of the hydrodynamic retarder is disengaged from the drive power flow in the motor vehicle drive train; and a second switching position where the power turbine is disengaged from the drive power flow in the motor vehicle drive train and the primary wheel of the hydrodynamic retarder is coupled in the drive power flow of the motor vehicle drive train in order to drive the primary wheel, and with a counter-rotating retarder in particular also the secondary wheel with the driving power from the motor vehicle drive train.

According to an especially advantageous further development of the invention, the mechanical disconnect clutch moreover includes a third switching position in which the power turbine as well as the primary wheel of the hydrodynamic retarder are disengaged from the drive power flow in the motor vehicle drive train. Accordingly, the primary wheel of the hydrodynamic retarder is not driven, nor is the power turbine dragged along undesirably by the drive engine due to exhaust gas energy that is too low.

According to one embodiment of the invention, the mechanical disconnect clutch is designed as a claw coupling, especially advantageously however as a synchronized claw coupling.

According to another embodiment it is provided that the power turbine and the primary wheel of the hydrodynamic retarder are connected via the mechanical disconnect clutch to an auxiliary drive of the drive engine, that is to a so-called PTO (power take-off). The shaft of the drive engine herein referred to as drive shaft can, for example, qualify as the auxiliary drive; or the drive shaft is the crankshaft of the internal combustion engine and the auxiliary drive is in a drive connection with the crank shaft via a gear drive inside the drive engine. Other arrangements are possible.

In order to protect the exhaust gas power turbine from torsional vibrations, a torsional vibration damping element is advantageously provided in the drive connection between the mechanical disconnect clutch and the power turbine, said element advantageously being in the embodiment of a hydrodynamic coupling. Such a hydrodynamic coupling is also equipped with two bladed wheels, which however both rotate. In particular, no third wheel as in a hydrodynamic converter is provided. The two bladed wheels together form a working chamber that can be filled with a working medium in order to transfer drive power hydrodynamically from one wheel to the other wheel. The hydrodynamic coupling therefore has a second working chamber in addition to the working chamber of the hydrodynamic retarder, and is therefore provided in addition to the hydrodynamic retarder.

The hydrodynamic coupling can be positioned physically separated from the hydrodynamic retarder. For example, the hydrodynamic coupling—viewed in an axial direction—is positioned on a first side of the mechanical disconnect clutch, whereas the hydrodynamic retarder is positioned on an opposite side of the mechanical disconnect clutch. Another embodiment provides that the hydrodynamic coupling is positioned coaxially to the hydrodynamic retarder, whereby in particular the axes of rotation of the hydrodynamic coupling and the hydrodynamic retarder are aligned with each other. Yet another embodiment provides that the hydrodynamic coupling is positioned in a radial direction beside the hydrodynamic retarder; in other words the axes of rotation of the hydrodynamic coupling and the hydrodynamic retarder are positioned parallel to one another, whereby the bladed wheels are positioned adjacent to one another in a common plane.

If the hydrodynamic coupling and the hydrodynamic retarder are operated with the same working medium, a common working medium resource, in particular an oil resource can be provided for both assemblies from which both working chambers are supplied with working medium. Being supplied with working medium can be understood as filling with working medium from a working medium reserve in the working medium resource, and emptying of the working chamber of working medium into the working medium reserve; in another embodiment where the working chamber of at least the hydrodynamic coupling and/or the retarder is/are not emptied or completely emptied, it can be understood as an exchange of the working medium that is present in the working chamber, in particular a continuous exchange of the working medium resource in order to discharge heat from the hydrodynamic assemblies. In particular, if both hydrodynamic assemblies are located near the drive engine or in or on the drive engine, for example because a drive occurs via the aforementioned auxiliary drive of the drive engine or drive power, or the power turbine is input into the auxiliary drive of the drive engine, then the oil resource of the drive engine can also be used to supply the hydrodynamic machines with the working medium oil. Such an oil resource serves in particular to lubricate the drive engine.

According to one favorable embodiment of the invention the power turbine and the primary wheel of the hydrodynamic retarder are always connected on the drive shaft of the drive engine via at least one, in particular via a multitude of spur gear stages. For example, a single spur gear stage or two spur gear stages are provided between the primary wheel of the hydrodynamic retarder and the drive shaft, whereas generally two or more spur gear stages are provided in the drive connection between the power turbine and the drive shaft. Based on these spur gear stages—viewed originating from the drive shaft—a step-up ratio into the fast mode can in each case be created, so that the primary wheel of the hydrodynamic retarder as well as the power turbine in an engaged drive connection by way of the disconnect clutch always rotate faster than the drive shaft of the drive engine.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing, wherein:

FIG. 1 illustrates a schematic of a motor vehicle drive train according to the present invention.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

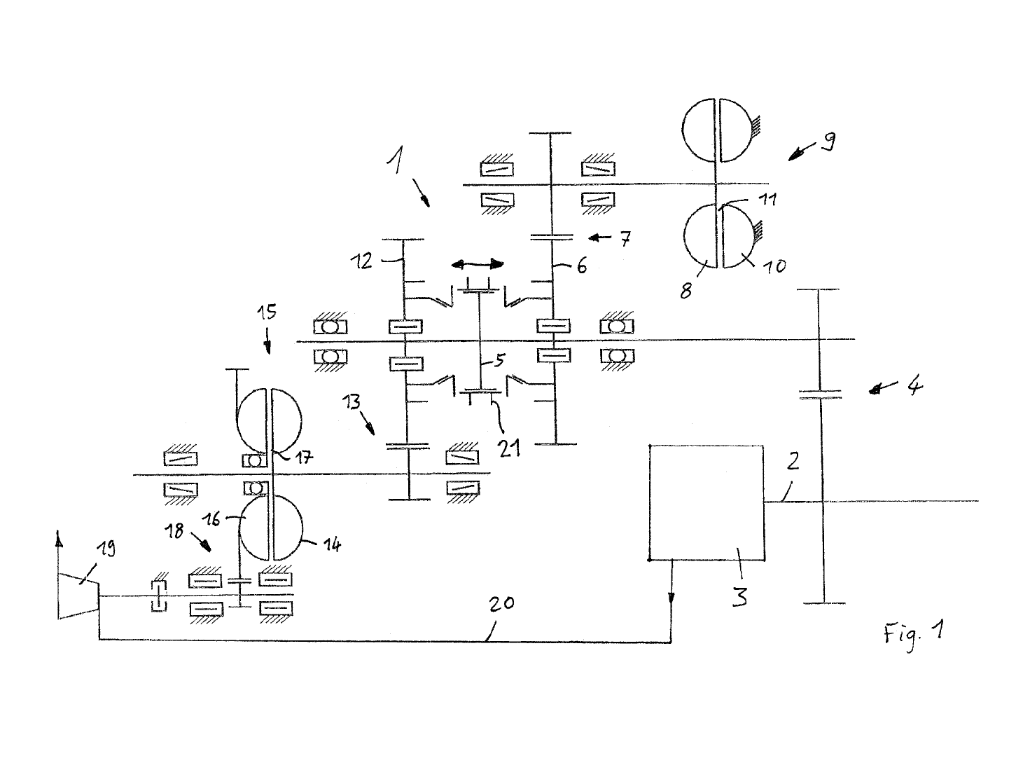

Referring now to FIG. 1, a schematic of a motor vehicle drive train is shown. The motor vehicle drive train includes a disconnect clutch 1 in the embodiment of a claw coupling that has three switching positions. Shown in particular is a purely mechanical drive connection of drive shaft 2 of drive engine 3 via (at least) one spur gear stage 4 to an input 5 of disconnect clutch 1, via a first output 6 of disconnect clutch 1 and (at least) one second spur gear stage 7 to primary wheel 8 of hydrodynamic retarder 9. Primary wheel 8, together with a secondary wheel 10 forms a working chamber 11 of hydrodynamic retarder 9.

A second output 12 of disconnect clutch 1 is in mechanical drive connection with turbine wheel 14 of hydrodynamic coupling 15 via (at least) one spur gear stage 13. Pump wheel 16 of hydrodynamic coupling 15 that together with turbine wheel 14 forms a working chamber 17 is in a mechanical drive connection via at least one spur gear stage 18 with exhaust gas power turbine 19 that is located in an exhaust gas stream 20 of drive engine 3.

Mechanical disconnect clutch 1 includes a shift sleeve 21 by way of which coupling input 5 can be optionally connected mechanically with either first coupling output 6 or with second coupling output 12 in order to accordingly produce either a purely mechanical drive connection between drive shaft 2 and primary wheel 8 of hydrodynamic retarder 9, in order to brake drive shaft 2 hydrodynamically; or to produce a hydrodynamic drive connection of drive shaft 2 with exhaust gas turbine 19, in order to propel drive shaft 2 with power turbine 19.

In a third switching position of mechanical disconnect clutch 1 illustrated in the current example, coupling input 5 is not connected with first coupling output 6 nor with second coupling output 12, so that no drive power transmission can occur between coupling input 5 and one of the two coupling outputs 6, 12.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A motor vehicle drive train, comprising:
a drive engine including a drive shaft and generating an exhaust stream;
a power turbine configured to convert exhaust energy into drive power, the power turbine being positioned in the exhaust stream, the power turbine being switchable into a drive connection with the drive shaft and capable to drive the drive shaft or an assembly downstream of the driveshaft in the drive power flow with the drive power of the drive turbine;
a hydrodynamic retarder including a driven bladed primary wheel and a bladed secondary wheel that is stationary or driven in the opposite direction of the primary wheel, the primary wheel and the secondary wheel forming a working chamber that can be filled with a working medium capable of braking the primary wheel hydrodynamically by torque transmission from the primary wheel to the secondary wheel by way of a working medium circuit; and
a mechanical disconnect clutch capable of disengaging the power turbine and the primary wheel of the hydrodynamic retarder from the drive power flow in the motor vehicle drive train.

2. The motor vehicle drive train according to claim 1, wherein the motor vehicle drive train is used in a commercial vehicle or rail vehicle.

3. The motor vehicle drive train according to claim 1, wherein the mechanical disconnect clutch includes at least two switching positions:
a first switching position where the power turbine is engaged in a drive connection with the drive shaft, and the primary wheel of the hydrodynamic retarder is disengaged from the drive power flow in the motor vehicle drive train; and
a second switching position where the power turbine is disengaged from the drive power flow in the motor vehicle drive train, and the primary wheel of the hydrodynamic retarder is coupled in the drive power flow of the motor vehicle drive train in order to drive the primary wheel.

4. The motor vehicle drive train according to claim 3, wherein the mechanical disconnect clutch further includes a third switching position in which the power turbine and the primary wheel of the hydrodynamic retarder are disengaged from the drive power flow in the motor vehicle drive train.

5. The motor vehicle drive train according to claim 1, wherein the mechanical disconnect clutch is a claw coupling.

6. The motor vehicle drive train according to claim 5, wherein the claw coupling is a synchronized claw coupling.

7. The motor vehicle drive train according to claim 1, wherein the power turbine and the primary wheel of the hydrodynamic retarder are connected by way of the mechanical disconnect clutch to an auxiliary drive of the drive engine.

8. The motor vehicle drive train according to claim 1, wherein a torsional vibration dampening element is provided in the drive connection between the mechanical disconnect clutch and the power turbine.

9. The motor vehicle drive train according to claim 8, wherein the torsional vibration damping element is configured to be a hydrodynamic coupling with a second working chamber.

10. The motor vehicle drive train according to claim 9, wherein the hydrodynamic coupling is in a position that is physically separated from the hydrodynamic retarder.

11. The motor vehicle drive train according to claim 10, wherein the hydrodynamic coupling and hydrodynamic retarder are located on opposite sides of the mechanical disconnect clutch.

12. The motor vehicle drive train according to claim 9, wherein the hydrodynamic coupling is positioned coaxially or in a radial direction beside the hydrodynamic retarder.

13. The motor vehicle drive train according to claim 9, wherein the hydrodynamic coupling and the hydrodynamic retarder share a common working medium resource, wherein the drive engine is lubricated with the same working medium.

14. The motor vehicle drive train according to claim 13, wherein the common working medium resource is an oil resource from which the working chambers are supplied with working medium.

15. The motor vehicle drive train according to claim 1, wherein the power turbine and the primary wheel of the hydrodynamic retarder are always connected to the drive shaft of the drive engine via at least one spur gear stage in such a way that a step-up ratio into a fast mode is created between the drive shaft and the power turbine and between the drive shaft and the primary wheel originating from the driveshaft.

16. The motor vehicle drive train according to claim 15, wherein the at least one spur gear stage is a multitude of spur gage stages.
